(19) United States
(12) Patent Application Publication
(10) Pub. No.: US 2006/0101300 A1
(43) Pub. Date: May 11, 2006

(54) Phase-locked-loop power control during standby

(76) Inventors: Matthew D. Singer, Belmont, CA (US); William L. Sanderson, Hillsboro, OR (US); Anthony M. Constantine, Beaverton, OR (US); Norm U. Adre, Beaverton, OR (US)

Correspondence Address: CARRIE A. BOONE, P.C., 2450 LOUISIANA, SUITE 400-310, HOUSTON, TX, 77006, US

(21) Appl. No.: 10/982,739

(22) Filed: Nov. 6, 2004

(51) Int. Cl. G06F 1/08

(52) U.S. Cl. 713/500

(57) ABSTRACT

A clock generator for supplying one or more clock signals to integrated circuits within a processor-based system is disclosed. The clock generator includes one or more PLLs and one or more configuration registers. The clock is supplied power from two different voltage sources, such that, during a standby mode of the system, the configuration registers continue to be powered with the lower of the two voltages while the PLLs are turned off. Upon returning from the standby mode, the clock generator is reinitialized according to a user-defined configuration, since the configuration registers retain data throughout standby mode. Alternatively, the clock generator may be reinitialized to a default state following standby mode, for backwards compatibility with prior art clock generators.

### FIELD OF THE INVENTION

This invention relates to clock generators used in processor-based systems and, more particularly, to the behavior of a clock generator during a reduced power mode of the system.

### BACKGROUND OF THE INVENTION

A clock generator is a device that produces one or more clocks at a specified frequency. Typically a standalone integrated circuit (IC) located on a motherboard of a processor-based system, the clock generator receives a source clock, such as a reference crystal, as its input, and produces a number of clocks for the other ICs on the motherboard. One or more phase-locked loops (PLLs) within the clock generator perform the frequency multiplication and division needed to generate the output clocks, which generally look like square waves (clock pulses).

The clock generator may also include a small memory for designating configuration registers. A bus, such as a serial bus, enables access to the registers, which are usually programmed during power-on of the processor-based system. The configuration registers may include one or more clock control registers, bus (such as PCI and USB) registers, frequency and spread spectrum control registers, and so on. The outputs of the clock generator, which may include a number of clock pulses running at different frequencies, are thus controlled by programming the configuration registers. The clock generator may include a default configuration in which the configuration registers are not consulted.

Typical processor-based systems include low- and reduced-power states, known in the industry as standby or suspend mode. Often, the processor-based system includes multiple standby modes, which are invoked under different operating conditions. When the system enters standby mode, the current configuration of the system is saved. (There are many schemes for saving the system state.) Upon exiting standby mode, the processor-based system is supposed to be restored to the exact configuration held prior to invoking the standby mode.

As with most other ICs on the processor-based system, the clock generator is typically turned off during standby mode, such that no voltage is supplied to the chip, and thus no PLLs are operable. The configuration registers, which are volatile, lose their configuration state during standby mode. Since the PLLs of the clock generator may alone draw 15-20 mAmps, there is some power savings gained by turning off the clock generator during standby mode. Upon exiting standby mode, power is restored to the clock generator, which is automatically programmed according to a default state, since the configuration registers are empty.

Where the configuration registers of the clock generator are programmed to a default state (or not programmed), the return from standby mode is inconsequential. The state of the clock generator before standby mode is the same as its state after standby mode. Where a user-defined configuration of the configuration registers is made prior to entering standby mode, however, the user-defined configuration is lost following standby. The inability to truly reflect the clock generator state following standby may be undesirable in some circumstances, such as during testing of the processor-based system.

Thus, there is a continuing need for a clock generator which overcomes the shortcomings of the prior art.

### BRIEF DESCRIPTION OF THE DRAWINGS

FIG. 1 is a block diagram of a clock generator, according to the prior art;

FIG. 2 is a block diagram of a clock generator, according to some embodiments;

FIG. 3 is a flow diagram showing how the clock generator of FIG. 2 is managed during and after standby mode, according to some embodiments; and

FIG. 4 is a block diagram of a processor-based system including the clock generator of FIG. 2, according to some embodiments.

### DETAILED DESCRIPTION

In accordance with the embodiments described herein, a clock generator of a processor-based system is disclosed, the clock generator including one or more PLLs and one or more configuration registers. The clock is supplied power from two different voltage sources, such that, during a standby mode of the system, the configuration registers continue to be powered with the lower of the two voltages while the PLLs are turned off. Upon returning from the standby mode, the clock generator may be reinitialized according to a user-defined configuration, since the configuration registers retain data throughout standby mode. Alternatively, the clock generator may be reinitialized to a default state following standby mode, for backwards compatibility with prior art clock generators.

In the following detailed description, reference is made to the accompanying drawings, which show by way of illustration specific embodiments in which the invention may be practiced. However, it is to be understood that other embodiments will become apparent to those of ordinary skill in the art upon reading this disclosure. The following detailed description is, therefore, not to be construed in a limiting sense, as the scope of the present invention is defined by the claims.

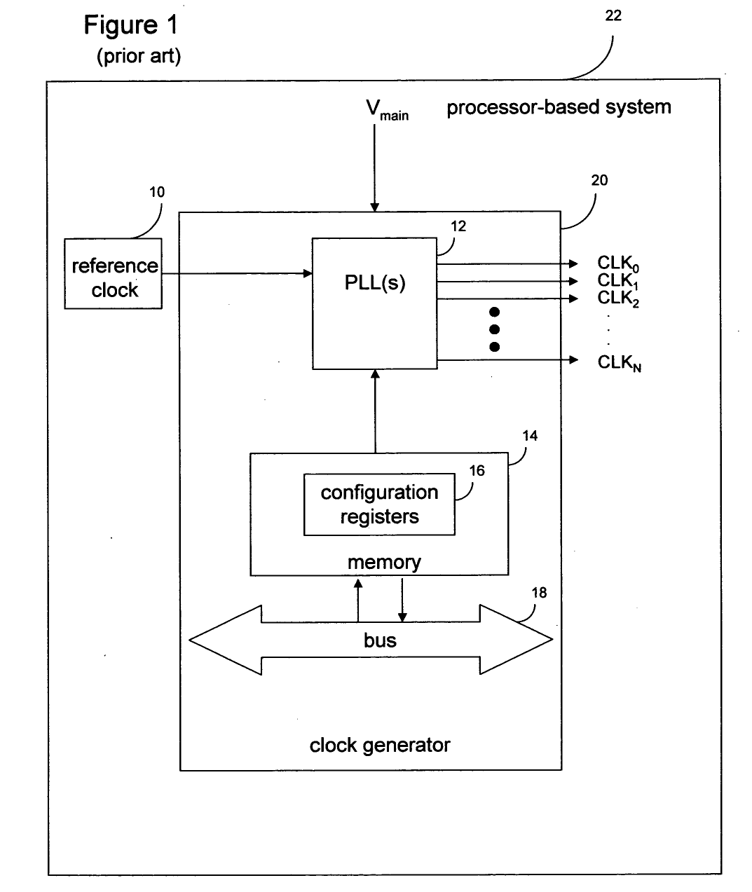

In FIG. 1, according to the prior art, a simplified block diagram of a processor-based system 22, including a clock generator 20 is depicted. The processor-based system may be a personal computer or server system in which the clock generator 20 is disposed on a motherboard. The clock generator 20 includes a plurality of PLLs 12 and a memory 14, in which configuration registers 16 may be programmed. The memory 14, which is volatile, connects to a bus 18, with which access to the configuration registers is made. The bus 18 may be a serial bus, a system management bus, or another type of bus. (A system management bus is a bus used for low-speed system management communications in some processor-based systems.)

The configuration registers 16 are programmed during execution of power-on firmware within the processor-based system. Alternatively, the configuration registers may be programmed by operating system software running in the processor-based system. The processor-based system 22 may also include runtime software with which an end user may modify the configuration registers after power-on. Absent any user-defined configuration of the clock generator 20, the power-on firmware (or operating system software) programs the configuration registers 16 with default values.

A reference clock 10 is fed to the clock generator 20 as an input. The reference clock, or reference crystal, supplies the source signal with which the PLLs 12 derive one or more output clocks, shown in FIG. 1 as CLK₀-CLK_{N}. The PLLs multiply the signal up, then divide the signal down until the desired base frequencies are achieved. The CLK₀-CLK_{N} clocks are supplied to other ICs of the motherboard upon which the clock generator 20 is disposed. Dedicated clocks for the PCI bus, the USB bus, and the processor are commonly among those clock pulses generated by the clock generator.

The clock generator is powered by a voltage shown as Vₘₐᵢₙ. The voltage Vₘₐᵢₙ is typically the main voltage supplied to the majority of ICs on the processor-based system. When the processor-based system is powered on, Vₘₐᵢₙ is supplied to the clock generator 20, as well as to other ICS on the motherboard (not shown) of the processor-based system 22. When the processor-based system 22 is turned off, the voltage Vₘₐᵢₙ is not supplied to the clock generator 20.

Likewise, when the processor-based system 22 enters standby mode, or another low-power state, the voltage Vₘₐᵢₙ is not available to the clock generator. This means that the PLLs are not running, data within the configuration registers is lost, and the clock generator produces no output clocks CLK₀-CLK_{N}. When the processor-based system 22 emerges from standby mode, the clock generator 20 is initialized to a default state, since the configuration registers 16 have no programming data. Systems returning from standby mode do not execute a power-on initialization sequence, as is the case with the initial system power-on (i.e., when the power-on button is activated). Instead, the processor-based systems execute a standby recovery initialization sequence, to return the system to its exact system state prior to standby mode. At least where the clock generator 20 has been altered according to a user-defined configuration prior to entering standby mode, the exact system state is not achieved following a return from standby mode.

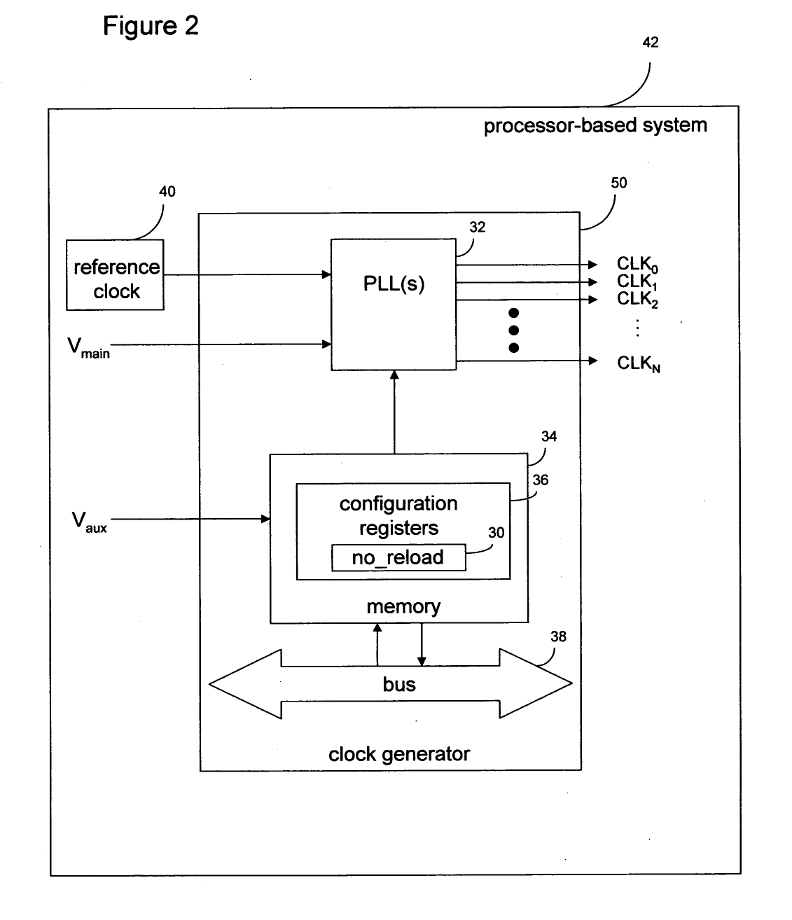

In FIG. 2, a simplified block diagram of a second processor-based system 42, including a clock generator 50 is depicted, according to some embodiments. The clock generator 50 is part of a processor-based system 42, in which a user-defined configuration of the clock generator 50 may be maintained following standby mode.

Similar to the clock generator 20 of FIG. 1, the clock generator 50 includes one or more PLLs 32 and a volatile memory 34 for the maintence of configuration registers 36. The configuration registers 36 are programmable via a bus 38. In some embodiments, the bus 38 is a system management bus.

In contrast to the clock generator 20, power to the configuration registers 34 and to the PLLs of the clock generator 50 is separately controlled. This enables a voltage to be selectively supplied to one of the components. In some embodiments, a voltage is supplied to the configuration registers 36 while no voltage is supplied to the PLLs 32 during standby mode of the processor-based system 42.

Further, the clock generator 50 is powered by two different voltage sources, Vₘₐᵢₙ and Vₐᵤₓ. The voltage, Vₘₐᵢₙ, is shown sourcing the PLLs 32. The voltage, Vₐᵤₓ, is shown sourcing the configuration registers 34.

By separating the PLLs 32 and the configuration registers 34 so that they can be sourced separately, and by making two voltage sources available to the clock generator 50, a user-defined configuration of the clock generator can be maintained after standby mode, in contrast with prior art clock generators. It is known that the PLLs of a typical clock generator draw approximately 15-20 mAmps of power while the configuration registers draw roughly 1 mAmp. By powering the configuration registers 36 but not the PLLs 32 during standby mode, significant power savings may result. Further, by supplying voltage to the configuration registers 36 during standby mode, the data contents of the registers is maintained during and following standby mode, such that a user-defined configuration submitted prior to standby mode is available when the clock generator 50 is reinitialized following standby mode.

Thus, the clock generator 50 of FIG. 2 is capable of blocking a voltage to the PLLs during standby mode (with expectant savings in power) and accessing one of two voltage sources (Vₘₐᵢₙ and Vₐᵤₓ). The processor-based system 42 is capable of maintaining the state of the configuration registers 36 in the clock generator 50 during standby mode. Table 1, below, shows how the clock generator 50 is sourced in the processor-based system 42, wherein the processor-based system is described as either being in standby mode or not being in standby mode.

TABLE 1
Voltage sources to the clock generator 50

| | no standby mode | standby mode |
|---|---|---|
| Phase-locked loop(s) 32 | Vₘₐᵢₙ | none |
| configuration registers 36 | Vₐᵤₓ | Vₐᵤₓ |

In an alternative embodiment, the configuration registers 36 may be powered by Vₐᵤₓ during standby mode, then switched to Vₘₐᵢₙ when the processor-based system 42 is not in standby mode. In both embodiments, the configuration registers receive Vₐᵤₓ during standby mode.

Since the configuration registers 36 control the characteristics of the PLLs 32, they are consulted during the restoration sequence of the clock generator 50. The PLLs are programmed according to the data in the configuration registers 36. Thus, the PLLs are configured to operate after standby mode in the manner assumed prior to standby mode.

There may exist circumstances in which it is desirable for the clock generator 50 to return to a default configuration following the standby mode. As shown in FIG. 2, the configuration registers 36 of the clock generator 50 include a no_reload bit 30, according to some embodiments. The no_reload bit 30, which may assume one of two states, specifies whether the configuration registers 36 are to be consulted following standby mode or not. When the no_reload bit 30 is in a first state, the configuration registers 36 are consulted during restoration of the PLLs following standby mode. When the no_reload bit 30 is in a second state, the configuration registers are not consulted; instead, the PLLs are programmed according to a predetermined default state.

Table 2 illustrates the effect of the no_reload bit on whether the configuration registers are consulted following standby mode. The no_reload bit is described as having an “off” or an “on” state, in which a “1” value represents one of the states and a “0” value represents the other state.

TABLE 2
Effect of no-reload bit state

| | configuration |
|---|---|
| | registers following standby mode |
| no_reload bit = off | used to program PLLs |
| no_reload bit = on | not used; PLLs programmed to default |
| | state |

The no_reload bit allows the clock generator 50 to be backwards compatible with prior art clock generators that do not support maintaining a user-defined configuration state following standby mode. Where such backwards compatibility is sought, the no_reload bit can be set to the “on” state.

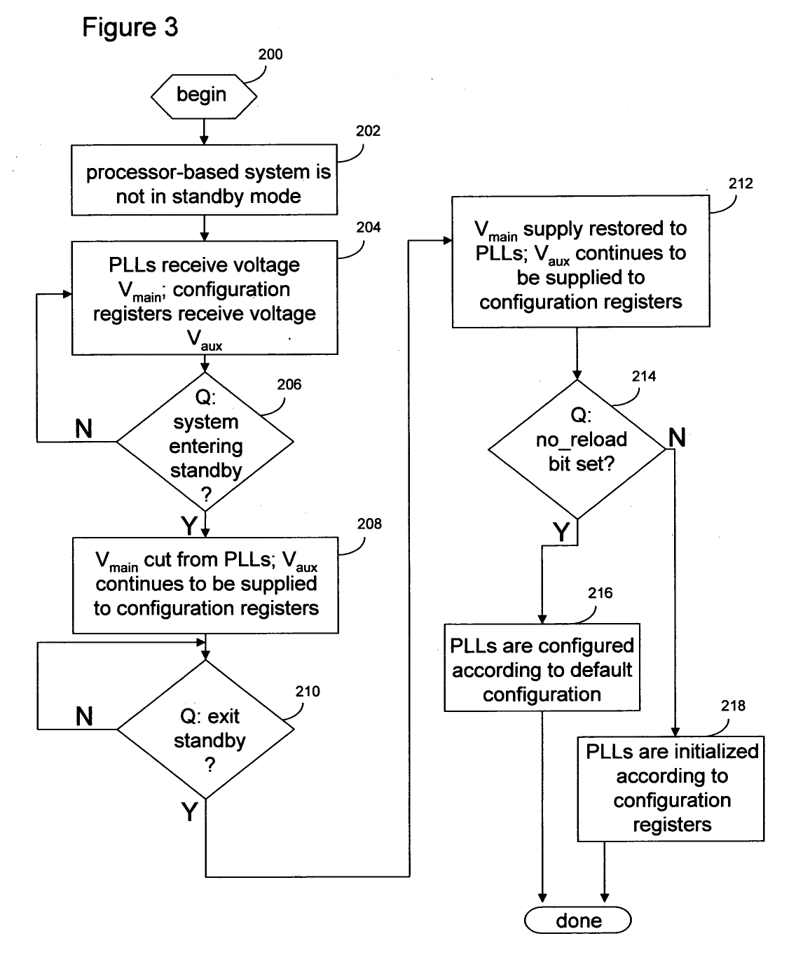

FIG. 3 depicts a method 200 performed by the processor-based system 42 to maintain the state of the configuration registers 36 despite the system entering standby mode. Initially, under the method 200, the processor-based system 42 is not in standby mode (block 202). At this point, the PLLs 32 receive voltage from the Vₘₐᵢₙ voltage source while the configuration registers receive voltage from the Vₐᵤₓ voltage source (block 204). The configuration registers 36 may be programmed to reflect an initial power-on state (which may or may not be a default state), a default state, or a user-defined state.

As long as the system does not enter standby mode (the “no” prong of block 206), the PLLs 32 are sourced by the voltage, Vₘₐᵢₙ, while the configuration registers 36 are sourced by the voltage, Vₐᵤₓ. Once the system enters standby mode (the “yes” prong of block 206), the voltage, Vₘₐᵢₙ, is removed from the PLLs 32, while the voltage Vₐᵤₓ remains available to the configuration registers 36 (block 208). The PLLs 32 are not operating while the processor-based system is in standby mode. In some embodiments, the auxiliary voltage, Vₐᵤₓ, is a voltage sufficient to maintain the data stored in the configuration registers.

While the system is in standby mode (the “no” prong of block 210), the clock generator 50 is maintained with Vₐᵤₓ supplying the configuration registers 36 and no voltage supplying the PLLs 32. Because the power drawn by the clock generator 50 is substantially lessened during standby mode, 1/20^{th} of its non-standby draw, by one measure, the processor-based system 42 advantageously experiences a power savings over prior art systems. Once the system 42 exits standby mode (the “yes” prong of block 210), the voltage, Vₘₐᵢₙ, is supplied to the PLLS; the configuration registers continue to receive the voltage, Vₐᵤₓ, uninterrupted (block 212). Accordingly, the state of the configuration registers 32 has, at all times, been maintained.

Since the configuration registers 36 were maintained during standby mode, the status of the no_reload bit 30 is known. Where the no_reload bit is not set (the “no” prong of block 214), the rest of the configuration registers 36 are consulted during initialization of the PLLs 32 (block 218). If, instead, the no_reload bit is cleared (the “yes” prong of block 214), the configuration registers are not consulted, and the PLLs are programmed according to a predetermined default configuration (block 216). Where the configuration registers 36 are not consulted, the backwards compatibility of the clock generator 50 with prior art clock generators is maintained.

By separating the voltage sourcing between the PLLs 32 and the configuration registers 36, substantial power savings can be realized during standby mode without losing the pertinent information needed to restore the clock configuration to its user-defined state following standby mode. Further, backwards compatibility is maintained using the clock generator 50, for those processor-based systems that execute legacy (old) software, those which are upgraded using legacy hardware, or for other reasons. Where the processor-based system 42 is being tested, or where the end user decides to “over-clock” the processor, the latest configuration of the clock generator can be maintained following standby with the above system and method.

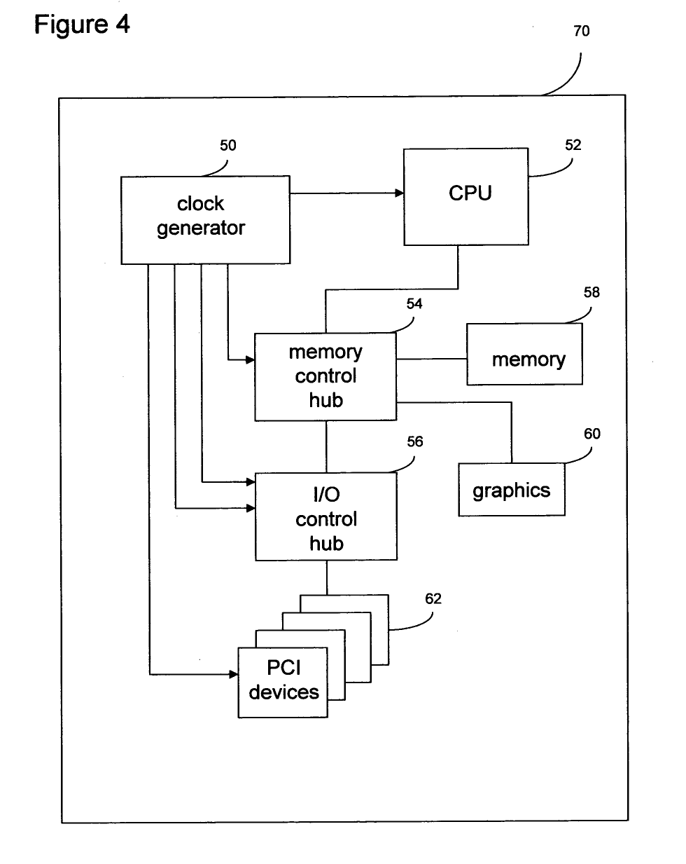

In FIG. 4, a processor-based system 70 is depicted, in which a plurality of clocks are generated for other integrated circuits on the system. The system 70 includes a central processing unit (CPU) 52, a memory control hub 54 with a memory 58 coupled thereto, an input/output (I/O) control hub 56, a graphics portion 60 coupled to the memory control hub 54, and a plurality of peripheral component interconnect (PCI) devices 62. The clock generator 50 produces a clock signal CLK1 for the CPU 52, a clock signal CLK2 for the memory control hub, clock signals CLK3 and CLK4 for the I/O control hub 56, and a clock signal CLK5 for the PCI devices 62. The processor-based system 70 represents one of a whole host of systems in which the clock generator can reside.

While the invention has been described with respect to a limited number of embodiments, those skilled in the art will appreciate numerous modifications and variations therefrom. It is intended that the appended claims cover all such modifications and variations as fall within the true spirit and scope of the invention.

We claim:

1. A clock generator for supplying clocks to integrated circuits of a processor-based system, the clock generator comprising:
a plurality of configuration registers in a volatile memory, the plurality of configuration registers being programmable; and
a plurality of phase-locked loops for producing a plurality of output clock signals, wherein the plurality of phase-locked loops is initialized according to either a predetermined state or according to data stored in the configuration registers;
wherein the plurality of configuration registers receives voltage from a first voltage source while the plurality of phase-locked loops receives voltage from a second voltage source when the processor-based system is in not standby mode.

2. The clock generator of claim 1, wherein the plurality of phase-locked loops receive no voltage and the and the plurality of configuration registers receive voltage from the first voltage source when the processor-based system is in standby mode.

3. The clock generator of claim 2, the plurality of configuration registers further comprising a bit, wherein the plurality of phase-locked loops is initialized following standby mode according to the predetermined state when the bit is set.

4. The clock generator of claim 3, wherein the plurality of phase-locked loops is initialized following standby mode according to the data stored in the configuration registers when the bit is not set.

5. A method, comprising:
initiating a standby mode in a processor-based system, the processor-based system including a clock generator with a phase-locked loop and a configuration register, wherein the clock generator is supplied with a first voltage; and
removing a second voltage from the phase-locked loop of the clock generator, wherein the second voltage was supplied to the phase-locked loop prior to the standby mode;
wherein the first voltage supplies the configuration register sufficiently for data contents within the configuration register to be maintained during the standby mode.

6. The method of claim 5, further comprising:
restoring the second voltage to the phase-locked loop of the clock generator upon return from the standby mode;
wherein the configuration register continues to receive the first voltage upon return from the standby mode.

7. The method of claim 6, further comprising:
identifying a bit within the configuration register, wherein the bit is in a first state; and
programming the phase-locked loop according to a predetermined configuration.

8. The method of claim 6, further comprising:
identifying a bit within the configuration register, wherein the bit is in a second state; and
programming the phase-locked loop according to the data contents of the configuration register.

9. A processor-based system, comprising:
a voltage source, for supplying a first voltage and a second voltage;
a standby mode, for temporarily putting the system in a low-power state; and
a clock generator, comprising a phase-locked loop and a configuration register, the clock generator receiving the first voltage and the phase-locked loop receiving the second voltage when the processor-based system is not in the standby mode, wherein the phase-locked loop is either programmed according to a predetermined state or programmed according to date stored in the configuration register;
wherein the phase-locked loop receives neither the first voltage nor the second voltage and the configuration register receives the first voltage when the processor-based system is in the standby mode.

10. The processor-based system of claim 9, wherein the first voltage is supplied to the phase-locked loop and to the configuration register when the system returns from standby mode.

11. The processor-based system of claim 10, wherein the configuration register maintains its data as the selector switches from the second voltage to the first voltage.

12. The processor-based system of claim 10, further comprising a bit, wherein the phase-locked loop is initialized according to a predetermined default configuration upon returning from standby mode when the bit is set.

13. The processor-based system of claim 12, wherein the phase-locked loop is initialized according to the data stored in the configuration register upon returning from standby mode when the bit is cleared.
